(19) United States
(12) Patent Application Publication
(10) Pub. No.: US 2025/0076679 A1
(43) Pub. Date: Mar. 6, 2025

(54) FLEXIBLE EYEWEAR ASSEMBLY

(71) Applicant: BRENT SHELDON, MIAMI, FL (US)

(72) Inventors: BRENT SHELDON, MIAMI, FL (US); GUY BROUSSEAU, JR., MARIEVILLE (CA)

(21) Appl. No.: 18/950,540

(22) Filed: Nov. 18, 2024

Related U.S. Application Data
(63) Continuation of application No. PCT/CA2023/050687, filed on May 17, 2023.
(60) Provisional application No. 63/343,179, filed on May 18, 2022.

(51) Int. Cl. G02C 5/02

(52) U.S. Cl. CPC G02C 5/02

(57) ABSTRACT

A flexible eyewear assembly is provided. The assembly includes first and second rigid frame portions, each having a respective opening therein and a deformable rigid bar extending between the first and second rigid frame portions. The assembly also includes a flexible component. The flexible component includes first and second lens retainers configured to engage with the first and second rigid frame portions along an inner edge thereof adjacent the respective opening, and sized to retain first and second lenses therein. The flexible component further includes a flexible bridge portion connecting the first lens retainer to the second lens retainer, the flexible bridge portion adapted to have the deformable rigid bar embedded therein and connect the first and second rigid frame portions when the first and second lens retainers are engaged with the respective rigid frame portions.

### CROSS-REFERENCE TO RELATED APPLICATIONS

This application is a Continuation of PCT Application No. PCT/CA2023/050687 filed on May 17, 2023, which claims priority from U.S. Provisional Patent Application No. 63/343,179 filed on May 18, 2022, the contents of which are incorporated herein by reference in their entirety.

### TECHNICAL FIELD

The following relates to flexible eyewear assemblies.

### BACKGROUND

Eyewear such as eyeglasses generally include a frame that supports one or more lenses. The frame typically includes a nose bridge or nose pieces that engage the user's nose to support the eyewear on the user's head. Eyeglasses also typically include a pair of arms attached to (or integral with) the frame, to further support the eyeglasses, e.g. by resting the arms on the user's ears or engaging their head in the temple region. Other eyewear may include other support elements such as straps or bands (e.g., in sports goggles).

Eyeglasses have traditionally utilized frames made from substantially rigid materials such as plastics, metals, or composite materials. The rigidity of these materials supports the lenses in the frames, and substantially maintains the shape of the eyeglasses such that they consistently fit on a user's head as intended. A drawback of this rigidity is that the frames can only typically withstand some flexure and can be prone to breakage or deformation.

Flexible components have been used in eyewear, for example, flexible arms and flexible portions of the eyewear frames. Various challenges can arise in construction, assembly, and use when incorporating flexible elements. For example, the flexibility should not cause the frames to deform and thus lose their shape over time. Other challenges include assembly complexities and costs associated with using multiple different materials.

It is an object of the following to address at least one of the above-noted disadvantages.

### SUMMARY

In one aspect, a flexible eyewear assembly is provided. The assembly includes first and second rigid frame portions, each having a respective opening therein and a deformable rigid bar extending between the first and second rigid frame portions. The assembly also includes a flexible component. The flexible component includes first and second lens retainers configured to engage with the first and second rigid frame portions along an inner edge thereof adjacent the respective opening, and sized to retain first and second lenses therein. The flexible component further includes a flexible bridge portion connecting the first lens retainer to the second lens retainer, the flexible bridge portion adapted to have the deformable rigid bar embedded therein and connect the first and second rigid frame portions when the first and second lens retainers are engaged with the respective rigid frame portions.

In another aspect, a flexible component for an eyewear is provided. The flexible component includes first and second lens retainers configured to engage with first and second rigid frame portions of the eyewear each having an opening therein. The first and second lens retainers are engaged along an inner edge of the respective rigid frame portions adjacent the respective opening, and are adapted to be sized to retain first and second lenses therein. The flexible component further includes a flexible bridge portion connecting the first lens retainer to the second lens retainer. The flexible bridge portion is configured to have a deformable rigid bar embedded therein to connect the first and second rigid frame portions when the first and second lens retainers are engaged with the respective rigid frame portions.

### BRIEF DESCRIPTION OF THE DRAWINGS

Embodiments will now be described with reference to the appended drawings wherein:

FIG. 1 is a perspective view of eyewear assembled with a flexible component;

FIG. 2 is a perspective view of the eyewear shown in FIG. 1;

FIG. 3 is an exploded perspective view of the eyewear shown in FIG. 2;

FIG. 4 is an enlarged perspective view of a portion of the assembled eyewear shown in FIG. 2;

FIG. 5 is a sectional perspective view along line V-V in FIG. 4;

FIG. 6a is a sectional plan view along line V-V;

FIG. 6b is a sectional plan view along a line above line V-V in FIG. 4 to include the deformable rigid bar;

FIG. 6c is a sectional plan view of the image shown in FIG. 6b illustrating flexure of the flexible portion and the embedded deformable rigid bar;

FIG. 7 is a sectional perspective view along line VII-VII in FIG. 2;

FIGS. 8A, 8B, and 8C are schematic illustrations showing insertion of the flexible component in a rigid component of the assembly, and insertion of a lens in the flexible component in assembling the eyewear; and

FIG. 9 is an enlarged perspective view of another portion of the assembled eyewear shown in FIG. 2.

### DETAILED DESCRIPTION

To provide flexibility in eyewear such as eyeglasses, rigid frame portions, separated at the bridge, can be held together by a flexible component that is overmolded or otherwise attached to the rigid frame portions to both position openings for the eyewear lenses in the appropriate location and provide flexibility in the eyewear at the bridge area. The flexible component can be positioned along the interior edge of the rigid frame portions and include lens retainers that hold the eyewear lenses therein. The flexible component can also embed a deformable rigid bar that is positioned between the rigid frame portions. The deformable rigid bar can be coupled directly to or be integral with the rigid frame portions or may be a separate component that is adjacent or otherwise placed between the rigid frame portions and the flexible component without any coupling or connection. Including such a deformable rigid bar can add to or otherwise customize the resistance to flexure of the flexible portion. Similarly, the deformable bar, via its inherent elastic deformability, can further encourage a return to rest for the overall assembly after being flexed. The deformable bar can also connect to the rigid frame portions to connect otherwise separate parts to align and hold them in place during assembly (e.g., during an overmolding process) to further assist in the accuracy and efficiency of such a process. Moreover, shape memory and other alloys can be used to enable a user to customize or otherwise adjust the rest position of the flexible portion, e.g., by including a slight bend to accommodate the specific user.

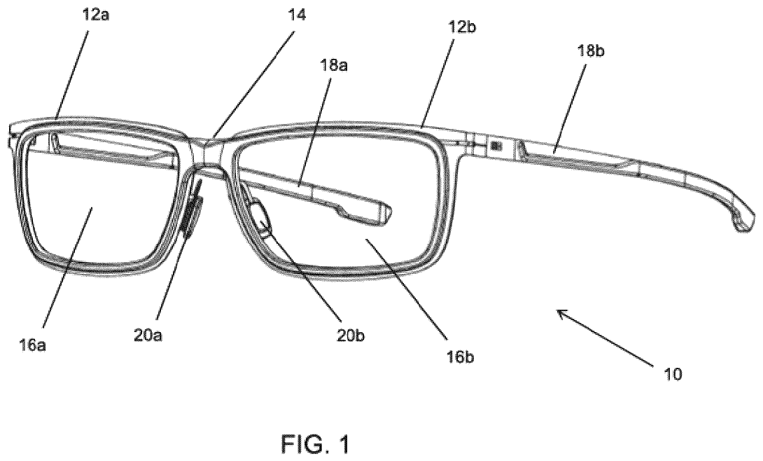

Turning now to the figures, FIG. 1 illustrates a perspective view of an example assembled eyewear 10, also referred to interchangeably herein as an eyewear assembly 10 or eyewear 10 for brevity. The eyewear 10 includes a pair of separate rigid frame portions 12, in this example a first rigid frame portion 12a and a second rigid frame portion 12b. A first arm 18a is connected to the first rigid frame portion 12a, and second arm 18b is connected to the second rigid frame portion 12b. The first rigid frame portion 12a includes or otherwise supports a first nose piece 20a, and the second rigid frame portion 12b includes or otherwise supports a second nose piece 20b.

The rigid frame portions 12a, 12b are supported by and positioned relative to each other, and in turn positioned on either side of the user's head aligned with their eyes, through engagement with a flexible component 14. The flexible component 14 fits within the rigid frame portions 12a, 12b as described in greater detail below, effectively connecting the first and second frame portions 12a, 12b via a bridge portion thereof. The flexible component 14 retains or otherwise holds or secures a pair of lenses 16, in this example a first lens 16a and a second lens 16b.

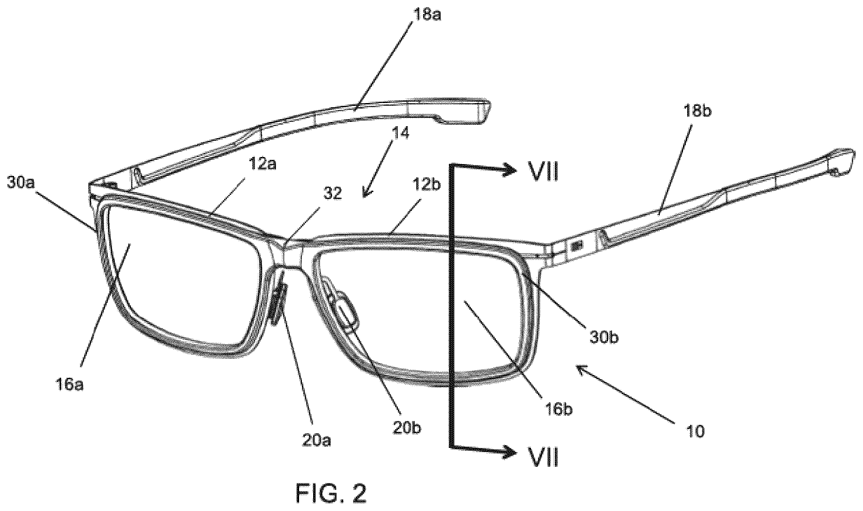

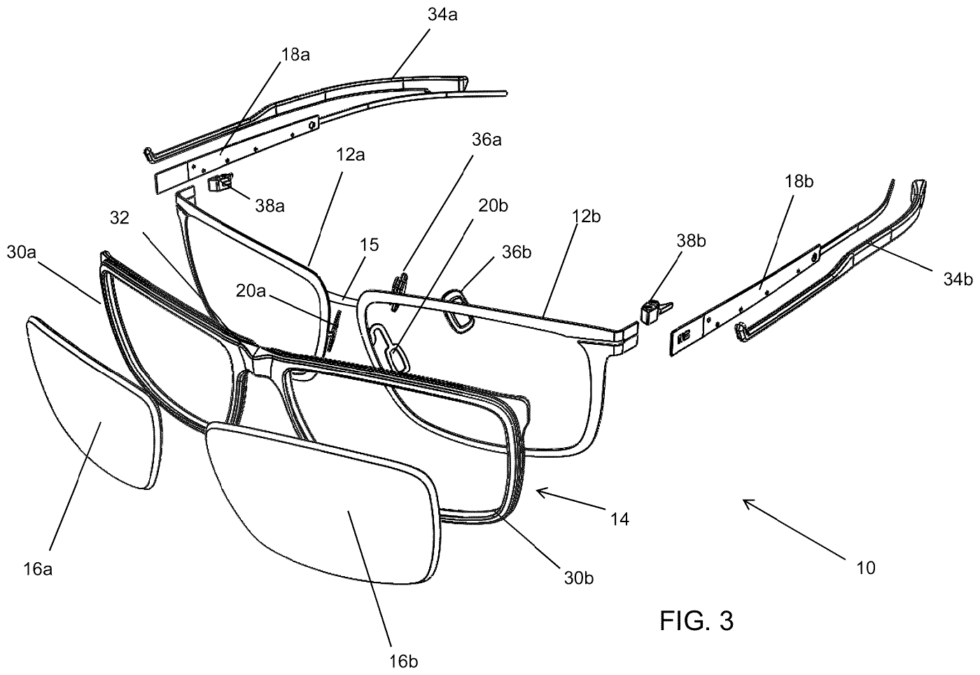

Additional details of the eyewear 10 are apparent from FIGS. 2 and 3. In an example embodiment, the flexible component 14, shown translucently in FIG. 2, includes a first lens retainer 30a and a second lens retainer 30b coupled to each other via a flexible bridge portion 32. The flexible bridge portion 32 enables the eyewear 10 to be flexed such that the rigid frame portions 12a, 12b and arms 18a, 18b attached thereto can be bent or otherwise separated or twisted relative to each other. This allows, for example, a user to slightly flex the arms 18a, 18b away from each other when placing the eyewear 10 on their head, with resiliency in the flexible bridge portion 32 causing the arms 18a, 18b to return towards each other and seat against the user's head and on their ears. This flexibility also resists breakage of the rigid frame portions 12a, 12b by permitting them to flex, twist and to a certain extent fold, e.g., if the eyewear 10 falls, is sat-upon by the user, is stuffed into a purse or bag, etc. As seen in FIG. 3, the eyewear 10 also includes a deformable but rigid bar 15, hereinafter referred to as the deformable rigid bar 15, which extends between the first and second rigid frame portions 12a, 12b as will be discussed in greater detail below.

As also shown in FIG. 3, the arms 18 can be connected to the respective rigid frame portion 12 via a respective hinge component 38. In this example, a first hinge component 38a connects the first arm 18a to the first rigid frame portion 12a, and a second hinge component 38b connects the second arm 18b to the second rigid frame portion 12b. In this example, each arm 18 has a molded temple piece 34 attached thereto. For example, a first molded temple piece 34a is attached to the outwardly facing surface (i.e., the surface that does not interact with the user's face) of the first arm 18a, and a second molded temple piece 34b is attached to the outwardly facing surface of the second arm 18b. The molded temple pieces 34 can be provided for aesthetics and/or for comfort. Each nose piece 20a, 20b can also have a respective nose pad 36a, 36b attached thereto as is known in the art.

In one embodiment, the flexible component 14 is overmolded to/on/with the rigid frame portions 12a, 12b and the deformable bar 15 using, for example, any suitable overmolding process. Overmolding, sometimes referred to as two times injection molding, is a process where a single part is created using two or more different materials in combination. Typically, a first material (or substrate) is partially or fully covered by an overmolded material during the manufacturing process. In this example implementation, the rigid frame portions 12a, 12b and the deformable bar 15 act as the substrate that is overmolded with the material used to create the flexible component 14 thereon. The flexible component 14 may be created using a flexible material, such as a softer plastic, rubber, thermoplastic rubber (TRP), thermoplastic polyurethane (TPU), or elastomer (e.g., PTE), or any other suitable material known in the art. It can be appreciated that the flexible component 14 would typically be overmolded to the rigid frame portions 12a, 12b, and deformable bar 15 prior to assembly of the lenses 16a, 16b and arms 18a, 18b.

The lenses 16a, 16b may then be inserted into the openings provided by the first and second lens retainers 30a, 30b respectively, of the flexible material 14 and held relative to the rigid frame portions 12a, 12b. For example, in the assembled state, the lenses 16a, 16b are retained against the respective rigid frame portions 12a, 12b with the flexible component 14 (having the embedded deformable bar 15) interposed therebetween.

In some additional or alternative embodiments, the flexible component 14 can also be inserted into and around the rigid frame portions 12a, 12b instead of using overmolding, as will be explained in greater detail below.

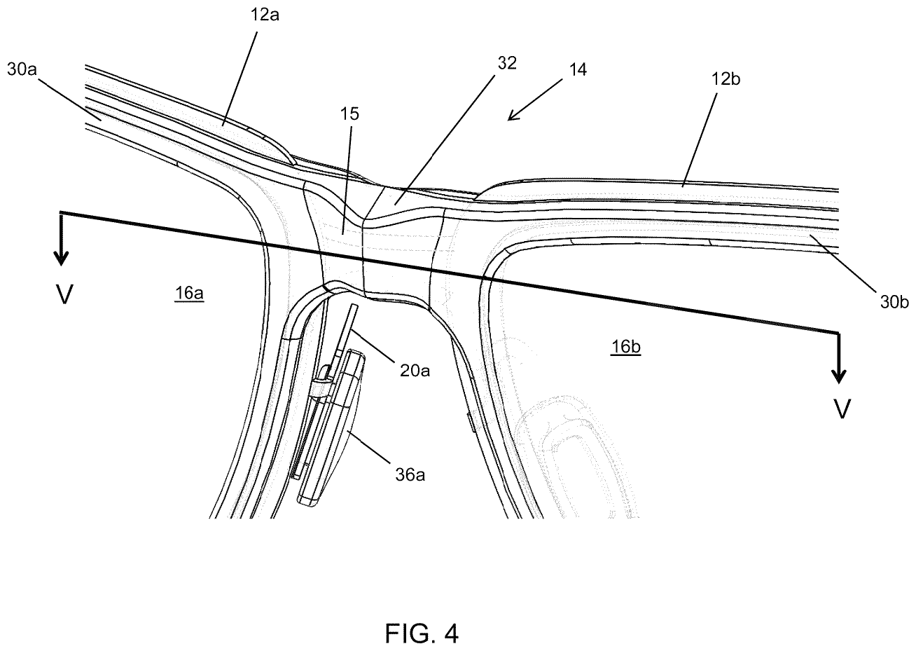

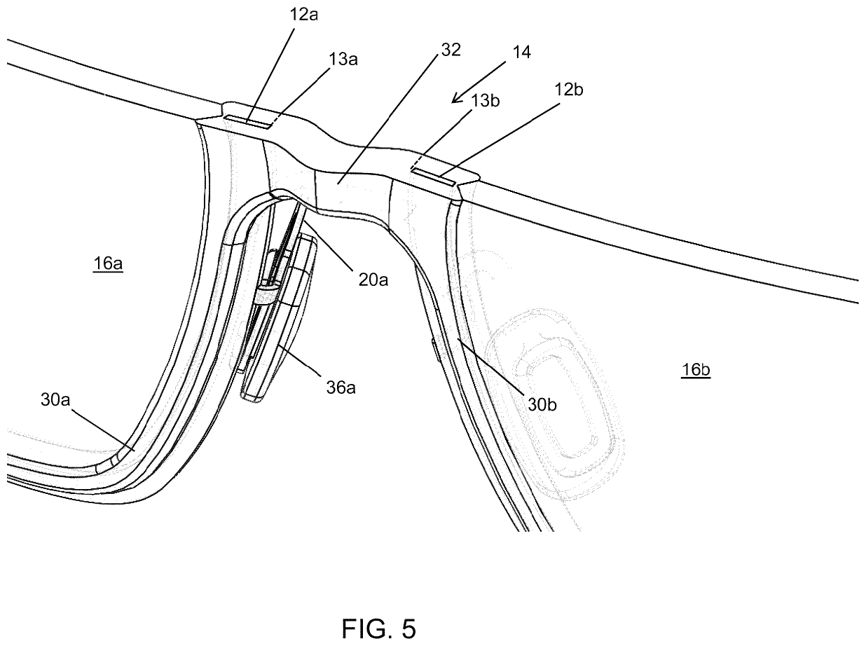

As can be seen in FIG. 4, the flexible component 14, whether overmolded onto the rigid frame portions 12 and deformable bar 15 or assembled as a separate member, surrounds the interior periphery of the openings in the rigid frame portions 12 and at least partially bears against the faces of rigid frame portions 12 on both sides to retain the rigid frame portions 12 together. In the example shown in FIG. 4, this is evident from the upper edges of the rigid frame portions 12a, 12b extending above the lens retainers 30a, 30b of the flexible component 14. When constructed as a separate piece, the flexible component 14 can be constructed to include slots, ridges, depressions, grooves, or other recessed areas to accommodate insertion of the edges of the rigid frame portions 12a, 12b on one side (e.g., on an outer periphery of the flexible component 14), and the lenses 16a, 16b on the other side (e.g., on an inner periphery of the flexible component 14). In this way, as shown in the cross-sectional view of FIG. 5, the relatively softer material of the flexible component 14 holds the rigid frame portions 12a, 12b together while providing a surface into which the lenses 16a, 16b can be inserted. For example, the inner periphery of the lens retainers 30a, 30b can be provided with a standard optician's groove to accept insertion of the lenses 16a, 16b. In this way, the lenses 16a, 16b are held firmly within the retainers 30a, 30b and in turn within the rigid frame portions 12a, 12b without physically contacting the rigid frame portions 12a, 12b. This allows insertion and removal of the lenses 16a, 16b into and out of the flexible component 14, thereby making assembly and maintenance of the eyewear 10 more convenient. The rigid material used in the frame portions 12a, 12b also inhibits the inner grooves on the lens retainers 30a, 30b from deforming and inadvertently releasing the lenses 16a, 16b when manipulated or worn by the user, all while the softer flexible component 14 is able to hold the lenses 16a, 16b.

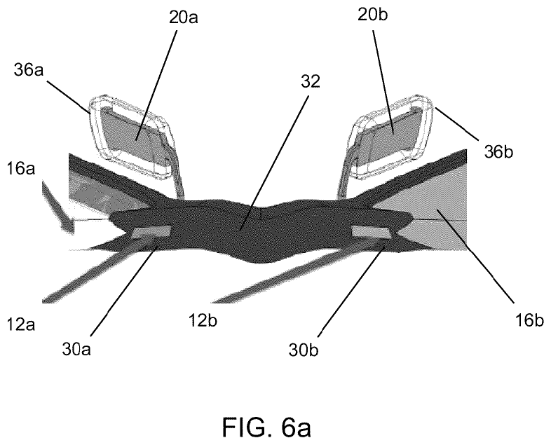

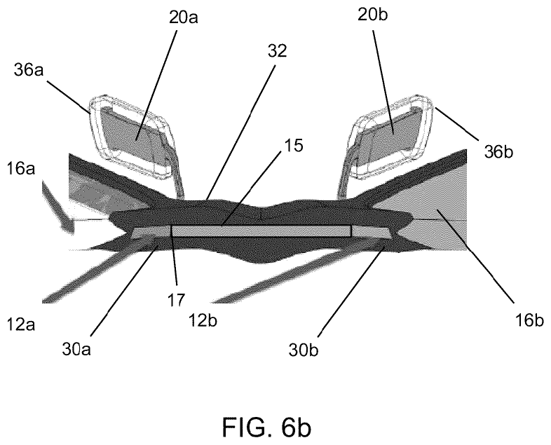

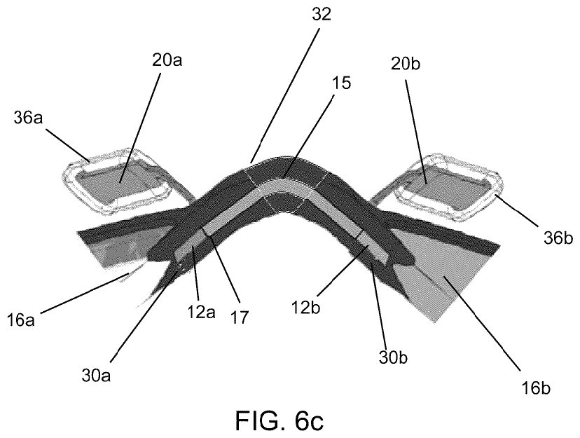

In the example shown in FIGS. 5 and 6, it can be seen that by overmolding the flexible component 14 onto the rigid frame portions 12a, 12b, the flexible component 14 can completely surround the areas of the rigid frame portions 12a, 12b near the bridge portion 32 to effectively hold the assembly together while providing the inherent flexibility of the flexible bridge portion 32. In this way, both flexibility and rigidity can be brought to the eyewear 10 with a convenient assembly process. The flexibility in the bridge portion 32 can enable shape memory or other resilient flexibility.

It can be appreciated that if the flexible component 14 is constructed separately rather than overmolded onto the rigid frame portions 12a, 12b, the bridge portion 32 would require slits or other passages, such as those shown by numerals 13a, 13b in FIG. 5, in order to allow the bridge portion 32 to completely surround the rigid frame portions 12a, 12b in the area shown in FIG. 5. In such examples, the slits or passages 13a, 13b could then be closed and fused (e.g., via melting or molding) to complete the assembly, or otherwise be provided with suitable resiliency to make it difficult to remove the rigid frame portions 12a, 12b from the flexible component 14 thereafter. Another slit (not shown) can be used to insert and thus embed the deformable bar 15.

FIG. 6a illustrates how the flexible component 14 surrounds the rigid frame portions 12a, 12b near the bridge portion 32 by virtue of the cross-section along line V-V in FIG. 4. FIG. 6b assumes that cross-section is taken through the deformable rigid bar 15 to illustrate the alignment and positioning of the bar 15 relative to the rigid frame portions 12a, 12b. The deformable bar 15 extends through the flexible bridge portion 32 between the first and second rigid frame portions 12a, 12b. In some example, implementations, the deformable rigid bar 15 can be made from an elastically deformable metal that is capable of being bent while returning to its original shape. Due to its inherent rigidity, the deformable rigid bar 15 provides strength to the central portion 32 while being embedded within the otherwise flexible bridge portion 32 of the flexible component 14 that may be overmolded as discussed above. In this way, the deformable rigid bar 15 can be chosen to have a thickness and material to fine tune the flexibility of the flexible bridge portion 32 while reforming to its original shape after being flexed as illustrated herein. For example, a rigidity factor of the eyewear may be determined and a suitable thickness and material for the deforming rigid bar 15 may be identified based on the determined rigidity factor.

FIG. 6b also illustrates that the deformable rigid bar 15 can extend between the first and second rigid frame portions 12a, 12b. It can be appreciated that the deformable rigid bar 15 is shown as a separate and distinct piece in FIG. 6b (with connection seams 17) for illustrative purposes only and that the deformable rigid bar 15 can also be integrally constructed with the first and second rigid frame members 12a, 12b to provide a single piece that is overmolded to form the flexible component 14. In some implementations, the deformable rigid bar 15 includes a separate material from the frame portions 12a, 12b to provide the elastic deformability discussed above. The deformable rigid bar 15 can be attached to the rigid frame portions 12a, 12b as illustrated in FIG. 6b or they may have a small separation or gap between the two. By being embedded within the flexible material of the flexible bridge portion 32, any flexure of the bridge portion 32 will likewise flex the deformable rigid bar 15, with any additional rigidity or resistance to the flexure imparted on the flexible bridge portion 32. When attached, for example, the deformable rigid bar 32 can be fastened, welded, fused, or otherwise coupled thereto. FIG. 6c illustrates the flexure of the deformable rigid bar 15 as the flexible bridge portion 32 is flexed. As noted above, when released, the deformable bar 15 would return to its original shape shown in FIG. 6b.

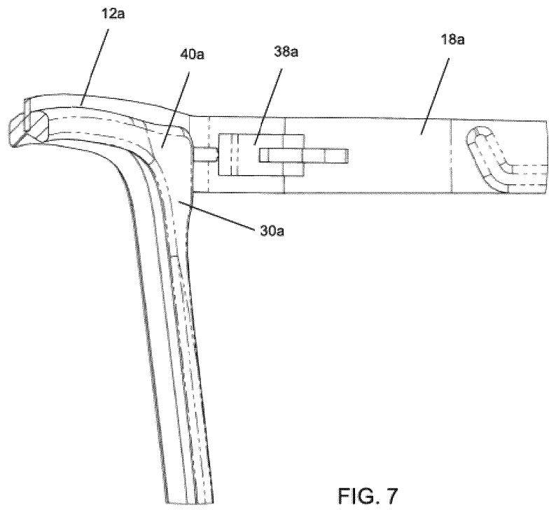

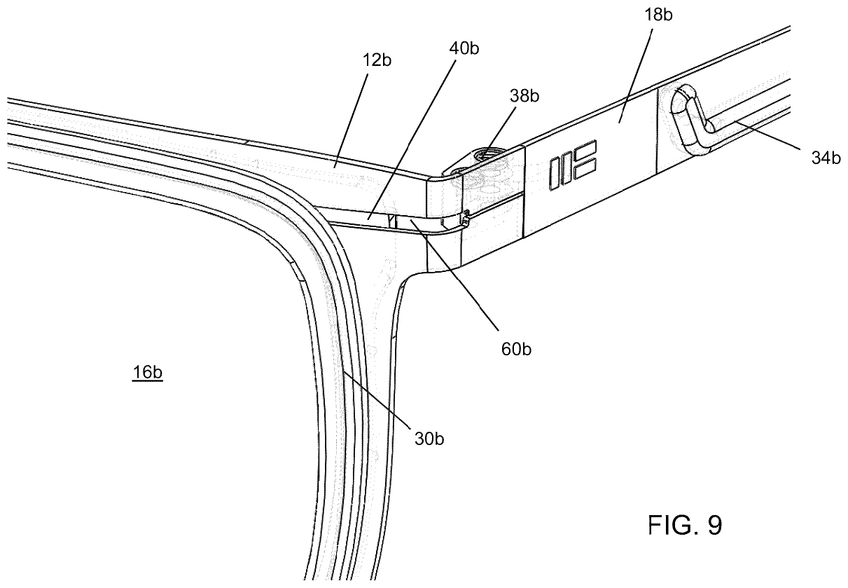

FIG. 7 provides another view of the flexible component 14 molded with or otherwise seated on to the first rigid frame portion 12a. FIG. 7 illustrates that the flexible component 14, in some additional or alternative embodiments, can also include a flap 40 at each corner, in the vicinity of the respective hinge components 38 and on the backside of the eyewear 10, to further stabilize the flexible component 14 against the rigid frame portions 12a, 12b. For example, a first flap 40a is located near the first hinge component 38a, and a second flap 40b (see also FIG. 9) is located near the second hinge component 38b.

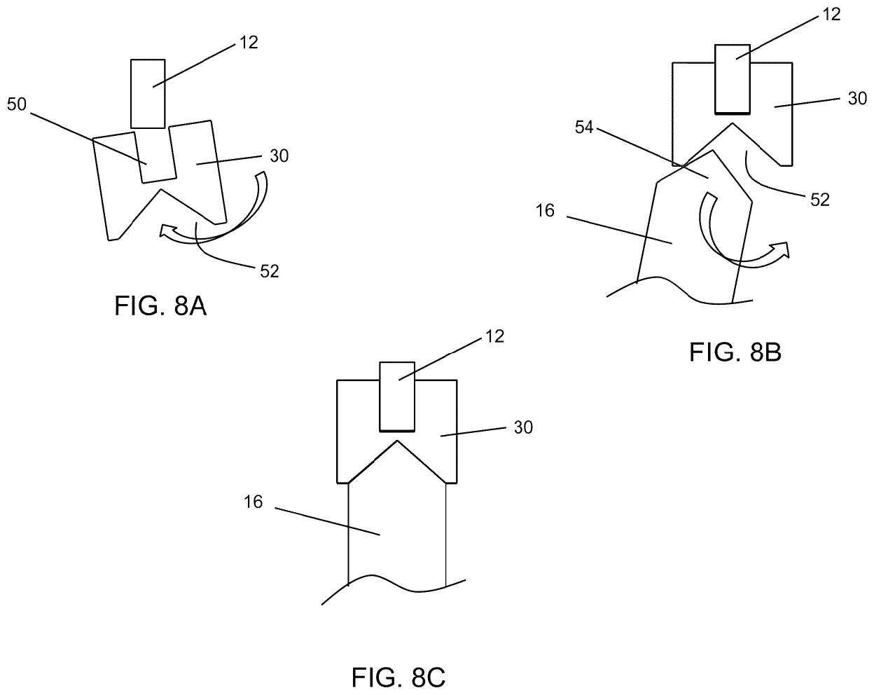

FIG. 8A illustrates a schematic cross-section of the lens retainer 30 portion of the flexible component 14. In some implementations, as can be seen in FIG. 8A, the flexible component 14 includes (or is otherwise provided with when overmolded with the rigid frame portion 12), a slot 50 or recess that permits the lens retainer 30 to be inserted and seat along the periphery of the inner edge of the centrally-open rigid frame portion 12. FIG. 8A provides an example in which a pre-molded flexible component 14 is assembled with the rigid frame portion 12 such that it is inserted along this inner edge to partially cover a portion of the front and back surfaces of the frame portion 12, as shown in FIG. 8B. It can be appreciated that when overmolding, the lens retainer 30 would be formed as shown in FIG. 8B following the overmolding process. FIG. 8B also illustrates insertion of the lens 16 into an inner slot or groove 52 (e.g., standard optician groove) provided in the lens retainer 30, that is opposite the slot 50. After insertion, as shown in FIG. 8C, the lens 16 is held firmly centered within the rigid frame portion 12, with the flexible component 14, particularly the lens retainer 30 of the flexible component 14, is interposed therebetween. In some examples, the slot 50 and groove 52 may be aligned to provide this relative positioning and facilitate both assembly and maintenance (e.g., to replace lenses 16) as mentioned above.

Turning now to FIG. 9, an enlarged portion of the example eyewear 10 is shown to illustrate that the rigid frame portions 12 (12b in this example) can, in some additional implementations, also include a slot 60b to provide some resiliency in the rigid frame portion 12b during assembly. FIG. 9 also shows the second flap 40b positioned behind the slot 60b.

For simplicity and clarity of illustration, where considered appropriate, reference numerals may be repeated among the figures to indicate corresponding or analogous elements.

In addition, numerous specific details are set forth in order to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. A flexible eyewear assembly comprising:
first and second rigid frame portions, each having a respective opening therein;
a deformable rigid bar extending between the first and second rigid frame portions; and
a flexible component comprising:
first and second lens retainers configured to engage the first and second rigid frame portions along an inner edge thereof adjacent the respective opening, and sized to retain first and second lenses therein; and
a flexible bridge portion connecting the first lens retainer to the second lens retainer, the flexible bridge portion adapted to have the deformable rigid bar embedded therein and connect the first and second rigid frame portions when the first and second lens retainers are engaged with the respective rigid frame portions.

2. The flexible eyewear assembly of claim 1, wherein the flexible component is overmolded to the first and second rigid frame portions.

3. The flexible eyewear assembly of claim 2, wherein the flexible bridge portion surrounds a portion of each of the first and second rigid frame portions.

4. The flexible eyewear assembly of claim 1, wherein each of the first and second lens retainers of the flexible component has an outer slot adapted to engage with the corresponding one of the first and second frame portions, and an inner groove adapted to retain the corresponding one of the first and second lenses therein.

5. The flexible eyewear assembly of claim 1, wherein the flexible component further comprises first and second flaps extending over a portion of a rear surface of respective one of the first and second rigid frame portions opposite the flexible bridge portion.

6. The flexible eyewear assembly of claim 1, wherein the flexible component is a separate component attached to the first and second rigid frame portions during assembly.

7. The flexible eyewear assembly of claim 6, wherein the flexible bridge portion comprises a pair of slits to permit the flexible bridge portion to surround a portion of each of the first and second rigid frame portions.

8. The flexible eyewear assembly of claim 1, further comprising first and second nose pieces coupled to respective ones of the first and second rigid frame portions.

9. The flexible eyewear assembly of claim 8, further comprising first and second nose pads coupled to respective ones of the first and second nose pieces.

10. The flexible eyewear assembly of claim 1, further comprising first and second arms coupled to respective ones of the first and second rigid frame portions.

11. The flexible eyewear assembly of claim 10, further comprising first and second hinges connecting the first and second arms to the respective ones of the first and second rigid frame portions.

12. The flexible eyewear assembly of claim 1, wherein each of the first and second rigid frame portions comprises a slit therein positioned in an area away from the flexible bridge portion when assembled.

13. A flexible component for an eyewear, the flexible component comprising:
first and second lens retainers configured to engage with first and second rigid frame portions of the eyewear each having an opening therein, the first and second lens retainers being engaged along an inner edge of the respective rigid frame portions adjacent the respective opening, and are adapted to be sized to retain first and second lenses therein; and
a flexible bridge portion connecting the first lens retainer to the second lens retainer, the flexible bridge portion being configured to have a deformable rigid bar embedded therein to connect the first and second rigid frame portions when the first and second lens retainers are engaged with the respective rigid frame portions.

14. The flexible component of claim 13, wherein the flexible component is overmolded to the first and second rigid frame portions.

15. The flexible component of claim 14, wherein the flexible bridge portion surrounds a portion of each of the first and second rigid frame portions.

16. The flexible component of claim 13, wherein the first and second lens retainers each have an outer slot configured to engage with the corresponding one of the first and second rigid frame portions, and an inner groove configured to retain the corresponding one of the first and second lenses therein.

17. The flexible component of claim 13, wherein the flexible component further comprises first and second flaps extending over a portion of a rear surface of respective one of the first and second rigid frame members opposite the flexible bridge portion.

18. The flexible component of claim 13, wherein the flexible component is a separate component attached to the first and second rigid frame portions during assembly.

19. The flexible component of claim 18, wherein the flexible bridge portion comprises a pair of slits to permit the flexible bridge portion to surround a portion of each of the first and second rigid frame members.
